(19) United States
(12) Patent Application Publication
(10) Pub. No.: US 2012/0007995 A1
(43) Pub. Date: Jan. 12, 2012

(54) ELECTRONIC FLIPBOOK SYSTEMS AND METHODS

(76) Inventor: Meredith Goldia Barrett, Long Branch, NJ (US)

(21) Appl. No.: 13/180,226

(22) Filed: Jul. 11, 2011

Related U.S. Application Data
(60) Provisional application No. 61/363,242, filed on Jul. 10, 2010.

(51) Int. Cl. H04N 5/225

(52) U.S. Cl. 348/207.1; 348/E05.024

(57) ABSTRACT

Systems and methods for creating an electronic flipbook are disclosed. The system can include a camera and an electronic media storage device. The storage device can include a control program stored thereon and being configured to obtain a predetermined number of images from the camera. The control program can sequentially display the predetermined number of images on an electronic display in a manner to create the illusion of flipping pages of a book.

### CROSS REFERENCE TO RELATED APPLICATION

The present application claims the benefit from earlier filed U.S. Provisional Patent Application No. 61/363,242 filed Jul. 10, 2010, which is incorporated herein in its entirety by reference.

### FIELD OF THE INVENTION

The present teachings relate to systems and methods for creating and displaying electronic flipbooks.

### BACKGROUND OF THE INVENTION

Systems and processes are known for making paper-based animated flipbooks for use at parties, business meetings, and other gatherings or events. However, there are no known ways of readily producing electronic-based flipbooks for view on electronic displays or that are capable of being widely distributed electronically using the internet.

Accordingly, there exists a need for systems and methods that can be easily used to produce and transmit electronic flipbooks.

### SUMMARY OF THE INVENTION

The present teachings provide a system for creating an electronic flipbook. The system can include a camera and an electronic media storage device. The electronic media storage device can have a control program stored thereon which can be configured to obtain a predetermined number of images from the camera and sequentially display the predetermined number of images on an electronic display in a manner to create the illusion of flipping pages of a book.

The present teachings also provide a method of creating an electronic flipbook. The method includes providing a camera and an electronic media storage device with software stored thereon. The camera is operated for a period of time to obtain a sequence of recorded image data corresponding to a recorded event. The software is used to obtain a predetermined number of images from the sequence of recorded image data and to sequentially display the predetermined number of images in a manner simulating that the images are being flipped as a flipbook.

The present teachings provide a further method of creating an electronic flipbook. This method includes providing a camera and operating the camera for a period of time to obtain a sequence of digitally recorded image data corresponding to a recorded event. The method includes obtaining a predetermined number of digital images from the sequence of recorded image data with a specified time interval occurring between each obtained digital image. The method includes running a video player that is configured to sequentially display the obtained predetermined number of images one-by-one to create the illusion of flipping pages of a book.

The present teachings still further provide a system for creating an electronic flipbook. The system includes a camera and a means for obtaining a predetermined number of images from the camera with a specified time interval occurring between each obtained digital image. The system also includes a means for sizing the images into a pre-determined format and transmitting the images to a folder and means for electronically displaying the predetermined number of images in a browser along with an animation to create the illusion of flipping pages of a book.

Additional features and advantages of various embodiments will be set forth, in part, in the description that follows, and will, in part, be apparent from the description, or may be learned by the practice of various embodiments. The objectives and other advantages of various embodiments will be realized and attained by means of the elements and combinations particularly pointed out in the description herein.

### BRIEF DESCRIPTION OF THE DRAWINGS

FIG. 1 shows a flowchart for the creation of an electronic flipbook according to the present teachings; and

FIG. 2 shows a screen shot of an electronic flipbook of the present teachings being displayed in a web browser.

It is to be understood that both the foregoing general description and the following detailed description are exemplary and explanatory only, and are intended to provide an explanation of various embodiments of the present teachings.

### DETAILED DESCRIPTION OF THE PREFERRED EMBODIMENTS

The present teachings relate to systems and methods for readily converting live or pre-recorded video or digital images into animated electronic flipbooks, such flipbooks being electronic representations of paper flipbooks. The systems and methods of the present teachings can include a video capture system and electronic flipbook software that can run on a host processing system that can convert sequentially captured video or digital images into separately viewable images. The electronic flipbook software can take imported images and electronically display them individually in a ‘flipped’ sequence to illustrate movement of the persons or characters that were electronically recorded. Moreover, the electronic flipbook software of the present teachings can make the individual digital images display as though the edge of each digital image is being curled back or forward as they are being flipped as if the electronic images were part of a paper flipbook that is being leafed through.

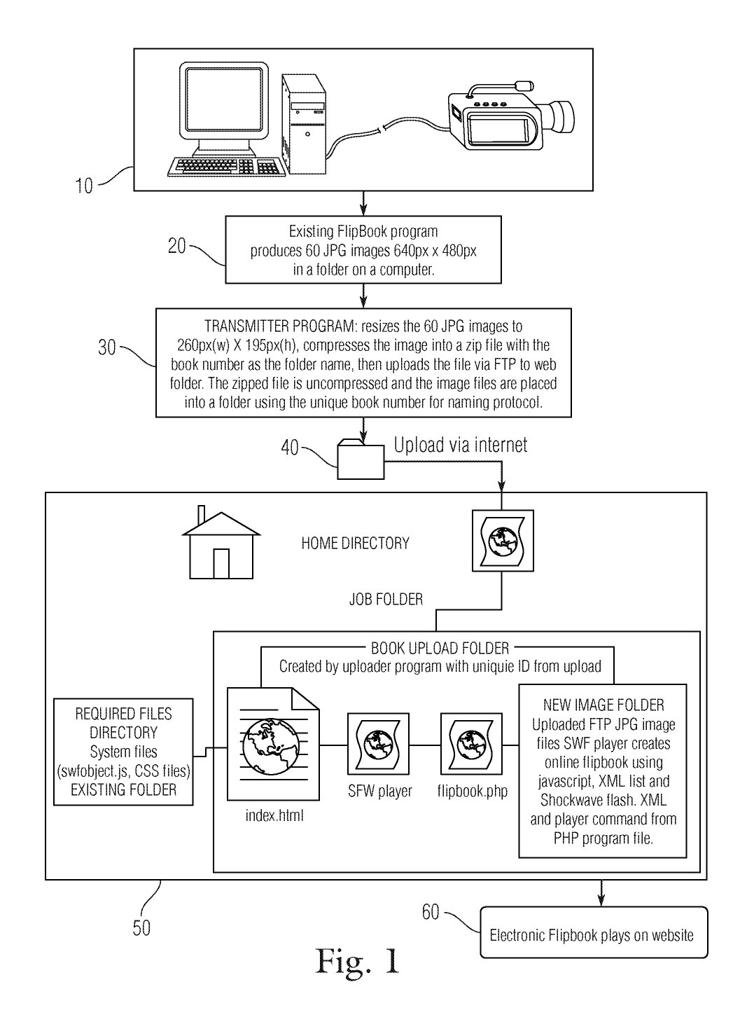

Initially, as shown at box 10 of FIG. 1, to create an electronic flipbook according to the present teachings, an digital image sequence can be recorded using a camera, such as a video camera, high-speed digital camera, web cam, stop-action camera, mobile-phone camera, and the like. For example, a party guest or host can be invited into a mobile video studio to perform a short skit which is videotaped, such as, for example, as a 7 second video.

When electronic image recording is complete, the image data can be stored on a computer in an appropriate video file format (e.g., avi, MPEG, QuickTime, or any future type of image format). For example, the image data can be stored on a local computer as shown in box 10. Throughout this patent application, the storage of image data and software can be achieved by way of one or more of; a hard drive on an individual computer, an external hard drive, a server hard drive, a web server, a CD, a DVD, in flash memory, a flash drive, a web folder, or any other known electronic media storage device or system.

Referring now to box 20, the recorded image data can then be parsed into separate stills which are then saved as separate image files. The separate images can be parsed and generated by using pre-existing software that creates physical flipbooks, such as flipbook creating software available from FLIPPIN FUN, LLC of Red Bank, N.J. For example, the pre-existing flipbook creating software can be run on a host processing system, such as the local computer as shown in box 10 of FIG. 1. Each of these images can be stored on the local computer hard drive as a separate image file (e.g., JPG, BMP, GIF, TIF, or any future type of image format). During electronic image recording and the image selection process, the separate stills created for each flipbook can be saved in a uniquely identified folder on the local computer using a “book number” identifier.

Each separate image file can represent a portion of the recorded video data at an instant of time within a particular time interval (e.g., the duration of the video capture). The number of separate stills which are created can be a predetermined number of images, for example, 60 photo images. The process can pull an individual image at a specified time interval (e.g., the first of every 10 images can be selected resulting in 60 out of 600 images being selected). For example, the pre-existing flipbook creating software can produce 60 BMP or JPG images each being 640 pixels by 480 pixels (w×h) and then store the images in the uniquely identified “book” folder on the local computer. The book folder can include a series of images that have been individually collated in a sequence corresponding to the order in which they were taken. The images can be numbered starting from 0. For example, the numbering can be from 0 to 59 for a series of 60 images.

During the creation of a physical paper flipbook, the separate images arranged in the book folder can be recorded, collated, printed, cut, stacked, and bound. The separate images can be cut to a uniform size and shape, and then stacked so each sequential image (e.g. from image 0 to image 59) is stacked one on top of the other. A cover is then applied to each stack of cut and stacked images. The pages and cover are then bound to form the physical paper flipbook.

The creation of an electronic flipbook does not require the physical printing, cutting and binding of the separate images making up the flipbook. Instead, the method, system and software of the present teachings can be used to manipulate and electronically display the series of images as a virtual electronic flipbook as will be discussed below.

Referring to box 30, a transmitter program can be used to resize, compress, and/or transfer the separate images making up the flipbook for further processing, creation, and display of the electronic flipbook. For example, the transmitter program can re-size and/or convert each of the 60 BMP or JPG images to JPG files each being 260 pixels by 195 pixels (w×h). The transmitter program can allow a user to locate and move the separate images from the desired book folder location on the local computer to another location (e.g. on the local computer or elsewhere) for processing into the electronic flipbook. For example, the transmitter program can allow a user to browse the individual book locations on the local hard drive (or as found on a separate computer, server, web folder, web server, flash drive, and the like) and select the desired set of separate images (e.g. the desired series of 60 images) that were created using the pre-existing flipbook creating software as discussed above. Alternatively, a program, such as the transmitter program, can be arranged to automatically identify the desired book folder holding the series of images.

The transmitter program can then be used to compress the set of images making up the particular flipbook into a zipped folder file. The zipped folder file can be named using the specific identifying book number. As shown at box 40, the transmitter program can take the zipped folder file and transfer it to a new folder location where the electronic flipbook can be created using the electronic flipbook creation programs of the present teachings, as will be further disclosed below. For example, the transmitter program can take the zipped folder file and upload it to a web server. Alternatively, the transmitter program can take the folder file including the re-sized images and transfer it to a new folder location without zipping or compressing the folder.

As shown at box 50, the new folder that receives the folder file can be referred to as a “job folder”. The job folder can be located in a directory, such as, in a home directory on a web server. The job folder can be a folder that has been previously created and named. For example, the pre-existing job folder can be named using a particular client identifier. The pre-existing job folder can be located on a web server, the hard drive of a local computer, a server, a web folder, the memory in a mobile phone, and the like. The transmitter program can upload the zipped folder file to the new folder location by way of FTP, or by way of any other protocol or transfer method.

As shown in box 50, the pre-existing job folder can contain standard shared system files. For example, the job folder can include a “Required Files Directory” containing system files arranged in a separate subfolder. The system files can include; swfobject.js, style.css, reset.css, as well as various generic image files based on the specifics of the job. The system files can include files required for the smooth operation of a video player, such as, for example, an ADOBE SHOCKWAVE flash player (from Adobe Systems Incorporated of San Jose, Calif.). Moreover, the system files can include files for the control of display formatting and colors. These system files can be manually loaded into the subfolder of the job folder at the time the job folder is created, directed to be automatically loaded by way of the transmitter program when the zipped folder file is placed into the job folder, or loaded along with the images files in the zipped folder file.

Upon being moved to the job folder, the zipped folder file can automatically unzip thereby creating a book folder and a new “image” subfolder within the book folder. The new image folder holds the separate images within the newly created book folder. The newly created book folder can be named using the specific identifying book number.

The book folder can also include files created to play the flipbook of the present teachings. These files can include index.html or index.php, flipbook.php and FlipbookPlayer.swf. These files can be automatically loaded into the book folder when the zipped folder file is placed into the job folder. Alternatively, the files can be loaded into the book holder along with the image files by way of the uploaded zipped folder file.

The flipbook.php file is a program file that creates a temporary XML file list of the image files.

The FlipbookPlayer.swf is customized code (e.g. JavaScript) that calls on the flipbook.php program to create the temporary XML file list and to play each image file one after the other (i.e. electronically flips the images in sequence) to give the impression of live action based on the movement of the actors that were electronically recorded. The FlipbookPlayer.swf can also include animation that can be overlaid onto the JPG images to display an electronic flipping book. More specifically, the individual images can be made to appear as though the edge of each image is being curled back or forward as they are flipping. As such, the individual images can be arranged to be viewed in a visual “frame” or skin that looks like a handheld flipbook. The FlipbookPlayer.swf can be programmed to provide different movement or flipping speeds. The FlipbookPlayer.swf can also include an animated video file of a particular client's logo that can be played to create cover art for the electronic flipbook. This file can be played before the start of the flipping images to create the illusion of the book cover opening to reveal the image pages. The animation in FlipbookPlayer.swf can be achieved using ADOBE AFTER EFFECTS (from Adobe Systems Incorporated of San Jose, Calif.) animation files with an alpha channel overlay to create the illusion of flipping pages.

The index.html or index.php file is the container file that is opened by the user and calls the SWF file and starts the electronic flipbook display process. The index.html or index.php file can also include code to achieve a customized landing page. For example, the landing page can be customized to display a client's branding/logo and/or various other information corresponding to a particular event at which the electronic flipbook was electronically recorded and created. The landing page can also be customized to contain links to other sites (including social networking sites) to which the client would like to drive traffic. Information on the traffic to the particular landing page can be captured and reported to the client.

Once the unzipped images are arranged in the specific book folder as set forth above, the programs of the present teachings can be triggered to run and the newly created electronic flipbook displayed for the user. In this regard, an e-mail can be sent to one or more users who have electronically recorded a flipbook skit which has been saved in a corresponding unique book folder. The e-mail can include a web link to the online electronic flipbook files corresponding to those users. Alternatively, the link can be posted on a website, such as FACEBOOK or TWITTER.

As shown at box 60, when the user clicks on the link, a web browser can open using the index.html page which loads the customized landing page and can instruct the FlipbookPlayer.swf file to load in the web page. Once the FlipbookPlayer.swf file is loaded, the program instructs the file flipbook.php to read the contents of the image folder and create a temporary XML database file listing the JPG images from 1 to 60. Next, the FlipbookPlayer.swf can open the internal JavaScript file that creates a program that will cause the JPG image files to be displayed in the web browser one at a time in sequential order. For example, the JPG images can be displayed for approximately 8 seconds with each image being displayed one at a time (7.5 images per second for 8 seconds=60 images). As discussed above, the FlipbookPlayer.swf is programmed to create the illusion of the flipping pages of a book. This can be done using a video player, such as, for example, within an ADOBE SHOCKWAVE flash player (from Adobe Systems Incorporated of San Jose, Calif.). After the electronic flipbook has played, the FlipbookPlayer.swf can include a replay button for the user that will reload the electronic flipbook when clicked.

Moreover, by capturing the video player output on the web browser, a video file of the electronic flipbook can be created. Such a video file could be forwarded to a user as an attachment to an e-mail. Such a video file could be uploaded to YOUTUBE or a social networking site, for example.

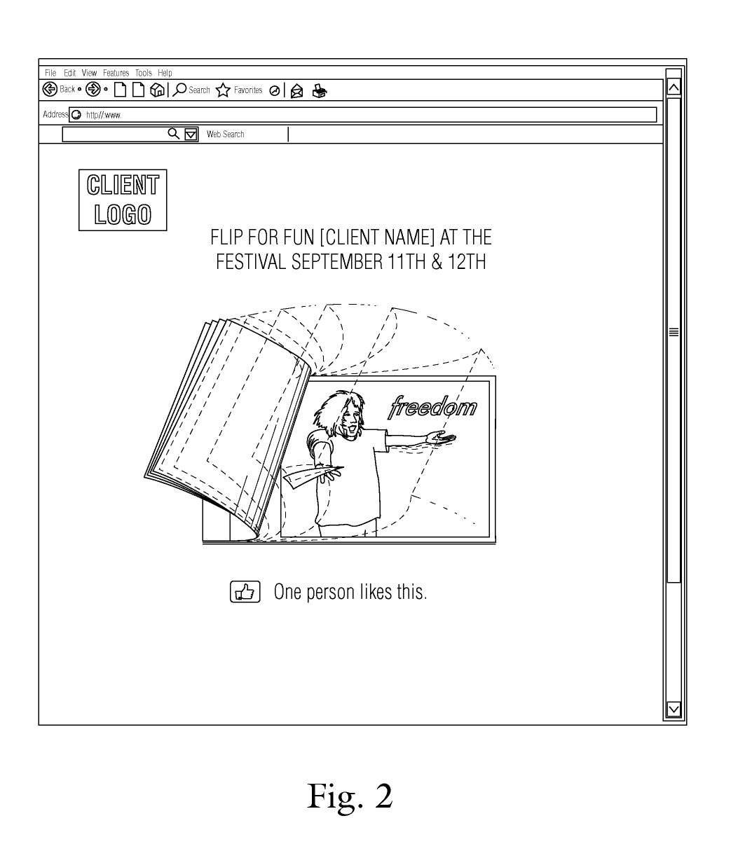

Referring to FIG. 2, a screen shot of an electronic flipbook of the present teachings being displayed in a web browser is shown. The electronic flipbook is shown after it has been played and the replay button is displayed. As can be seen, the images are displayed on a customized landing page within a visual frame or skin that looks like a handheld flipbook. Moreover, as previously set forth above, as the image files are displayed one at a time within the frame or skin, an animation can be used to make the images appear as though the edge of each image is being curled back or forward as they are flipping.

According to various embodiments, the system and method of the present teachings can be implemented on a local computer, a local computer and a server, more than one computer, a combination of a local computer and a web server, on a mobile phone or smartphone having a camera feature, an FTP site, a photo-sharing site, or a combination thereof. When implemented on a mobile phone or smartphone, the electronic flipbook system and method of the present teachings can be in the form of an “app” that can be downloaded onto the phone for use with the hardware of the phone.

Those skilled in the art can appreciate from the foregoing description that the present teachings can be implemented in a variety of forms. Therefore, while these teachings have been described in connection with particular embodiments and examples thereof, the true scope of the present teachings should not be so limited. Various changes and modifications may be made without departing from the scope of the teachings herein.

What is claimed is:

1. A system for creating an electronic flipbook comprising:
a camera; and
an electronic media storage device, the storage device having a control program stored thereon configured to:
obtain a predetermined number of images from the camera; and
sequentially display the predetermined number of images on an electronic display in a manner to create the illusion of flipping pages of a book.

2. The system of claim 1, wherein the control program is configured to display an animation along with the sequentially displayed images to simulate that the images are being flipped.

3. The system of claim 2, wherein the animation simulates an edge of each image being curled as the images are sequentially displayed.

4. The system of claim 1, wherein the control program is configured to obtain the predetermined number of images from the camera with a specified time interval between each image.

5. The system of claim 1, wherein the control program is configured to sequentially display the images using a video player in a browser.

6. The system of claim 1, wherein the control program includes a first program that converts the predetermined number of images taken from the camera into a viewable format and transmits the images to a web server.

7. The system of claim 6, wherein the control program includes a second program that takes the images that have been transmitted to the web server and creates a database file of the images.

8. The system of claim 7, wherein the control program includes a third program that takes the database file of the images and displays them sequentially in a browser in a manner that simulates that the images are being flipped.

9. The system of claim 1, wherein the system is adapted for use on a mobile phone having a camera.

10. A method of creating an electronic flipbook comprising:
providing a camera;
providing an electronic media storage device with software stored thereon;
operating the camera for a period of time to obtain a sequence of recorded image data corresponding to a recorded event;
using the software to obtain a predetermined number of images from the sequence of recorded image data and to sequentially display the predetermined number of images in a manner simulating that the images are being flipped as a flipbook.

11. The method of claim 10, wherein using the software includes simultaneously displaying an animation along with the sequentially displayed images that simulates that the images are being flipped.

12. The method of claim 10, wherein using the software to obtain the predetermined number of images from the sequence of recorded image data includes obtaining images with a specified time interval between each image.

13. The method of claim 10, wherein using the software to sequentially display the images includes using a video player with a browser to sequentially display the images.

14. The method of claim 10, wherein the method is performed using a mobile phone having a camera.

15. A method of creating an electronic flipbook comprising:
providing a camera;
operating the camera for a period of time to obtain a sequence of digitally recorded image data corresponding to a recorded event;
obtaining a predetermined number of digital images from the sequence of recorded image data, a specified time interval occurring between each obtained digital image; and
running a video player that is configured to sequentially display the obtained predetermined number of images one-by-one to create the illusion of flipping pages of a book.

16. The method of claim 15, wherein running the video player includes displaying an animation that simulates an edge of each displayed image being curled as the images are sequentially displayed.

17. The method of claim 15, wherein obtaining a predetermined number of digital images includes uploading the digital images into a folder on a web server.

18. The method of claim 16, wherein running the video player includes running the video player in a browser to sequentially display each image.

19. The method of claim 15, wherein the method is performed using a mobile phone having a camera.

20. A system for creating an electronic flipbook comprising:
a camera;
means for obtaining a predetermined number of images from the camera, a specified time interval occurring between each obtained digital image;
means for sizing the images into a pre-determined format and transmitting the images to a folder; and
means for electronically displaying the predetermined number of images in a browser along with an animation to create the illusion of flipping pages of a book.
